(19) United States
(12) Patent Application Publication
(10) Pub. No.: US 2005/0226456 A1
(43) Pub. Date: Oct. 13, 2005

(54) Loudspeaker edge

(76) Inventors: Shinya Tabata, Mie (JP); Hidekazu Tanaka, Singapore (JP)

Correspondence Address: WENDEROTH, LIND & PONACK, L.L.P., 2033 K STREET N. W., SUITE 800, WASHINGTON, DC, 20006-1021, US

(21) Appl. No.: 10/517,261

(22) PCT Filed: Jun. 26, 2002
(86) PCT No.: PCT/JP02/06431

§ 371 Date: Dec. 7, 2004

(51) Int. Cl. H04R 25/00

(52) U.S. Cl. 381/398; 381/423

(57) ABSTRACT

The present invention provides a loudspeaker which is excellent in acoustic characteristics such as frequency characteristics and distortion characteristics. Particularly, edge 1 is formed in such manner that a thickness of sectional shape in radial direction increases from inner periphery portion 12 toward outer periphery portion 13. Due to this structure, a mechanical impedance of edge 1 against diaphragm 2 is decreased and bad influences on a vibration mode of the diaphragm are suppressed, and also, vibration energy is absorbed by the thick portion of the outer periphery portion, thereby suppressing standing waves of the diaphragm. The structure increases an efficiency of the medium and high frequency range sounds radiated from the loudspeaker, and further, greatly contributes to improve frequency characteristics, nonlinear distortion characteristics, and transient characteristics.

### TECHNICAL FIELD

The present invention relates to a loudspeaker mainly used in acoustic apparatus.

### BACKGROUND ART

Firstly, a conventional loudspeaker is described with reference to FIG. 19 showing a top view of a conventional long shaped loudspeaker (especially, loudspeakers with large length to width ratio in shape, which are hereafter generally recited as “slim loudspeakers”) and FIG. 20 showing a two-directional sectional view in a lengthwise and a widthwise directions of the slim loudspeaker.

Magnetic circuit 6 shown in FIG. 20 comprises lower plate 6a, ring-shaped magnet 6b, and upper plate 6c. Frame 5 is bonded to the magnetic circuit 6. An outer periphery of diaphragm 2 is bonded to the frame 5 via edge 1, and an inner periphery thereof is bonded to voice coil 3 inserted in magnetic gap 6d of the magnetic circuit 6.

An outer periphery of damper 4 is bonded to the frame 5, and an inner periphery is bonded to the voice coil 3 to support the voice coil 3.

As the edge 1 used in such a loudspeaker, there are a “fixed edge” which is formed of an extended potion of a diaphragm material, and a “free edge” using other material. Structurally, the former is formed in one-piece structure using a same paper material as the diaphragm by extending a portion thereof, and a plurality of corrugations that are similar to the outer periphery of the diaphragm are formed to provide compliance. The latter is generally made of urethane foam, foamed rubber or the like materials, which are formed into sheet and thermally formed into a predetermined shape such as a corrugation edge and a roll edge.

The edge 1 is required to have two functions, these are;
(1) to support the diaphragm 2 so as not to induce troubles in vibration and also to reproduce sound free from nonlinear distortion, and
(2) to suppress an anti-resonance and a partial resonance of the diaphragm 2 including the edge 1 by absorbing vibration energy of the diaphragm 2 so that the reproduced sound quality is not badly affected by a generation of dip on “output sound pressure level vs. frequency” characteristics of the loudspeaker. To address the above requirement, the edge 1 is required to have appropriate stiffness and to be excellent in mechanical internal losses and in linearity against a displacement of the diaphragm 2 due to a driving force. In order to satisfy the requirements, a material of the edge 1, a sectional shape along the radial direction, a weight and weight distribution had been studied.

Regarding the shape and structure of the edge 1, which supports the outer periphery of diaphragm 2, corresponding to various shapes of loudspeakers such as slim loudspeakers mentioned above, there are problems to be solved. That is, the results of the studies are not satisfactory about “sectional shape, weight and weight distribution, and stiffness” in relation to “mechanical internal losses and linearity of displacement against driving force.”

In order to address the above problems of the conventional edge, the present invention provides a loudspeaker having an edge improved in sectional shape, weight and weight distribution and stiffness distribution, taking into account of a relationship of the displacement linearity of the edge itself and a mechanical impedance of a diaphragm. The loudspeaker of the present invention is excellent in acoustic characteristics such as frequency characteristics, transient characteristics, and distortion characteristics.

### DISCLOSURE OF THE INVENTION

The loudspeaker of the present invention comprises at least a magnetic circuit, a frame connected to the magnetic circuit, and a diaphragm which is connected to a voice coil with an inner periphery, and is connected with an outer periphery to the frame via an edge. The voice coil is inserted into a magnetic gap of the magnetic circuit, and a thickness of a sectional shape of an inner periphery of the edge is thinner than a thickness of a sectional shape of an outer periphery. The edge is made of an elastic resin or a foamed resin.

### BRIEF DESCRIPTION OF THE DRAWINGS

FIG. 1 is a top view of a loudspeaker in one embodiment of the present invention.

FIG. 2 is a two-directional sectional view of the loudspeaker in FIG. 1.

FIG. 3 is an enlarged sectional view of an edge which is an essential portion in one modification of the present invention.

FIG. 4 is an enlarged view of an edge in another modification of the present invention.

FIG. 5 is an enlarged view of an edge in still another modification of the present invention.

FIG. 6 is a top view of another loudspeaker of the present invention.

FIG. 7 is a two-directional sectional view of the loudspeaker in FIG. 6.

FIG. 8 is a two-directional sectional view of yet another loudspeaker of the present invention.

FIG. 9 is a two-directional sectional view of still another loudspeaker of the present invention.

FIG. 10 is a two-directional view in a modification of still another loudspeaker the present invention.

FIG. 11 is a two-directional sectional view of yet another loudspeaker of the present invention.

FIG. 12 is a two-directional sectional view in a modification of yet another loudspeaker the present invention.

FIG. 13 is a top view of other loudspeaker of the present invention.

FIG. 14 is a two-directional view of the other loudspeaker.

FIG. 15 is a top view of other loudspeaker of the present invention.

FIG. 16 is a two-directional view of the other loudspeaker.

FIG. 17 is a two-directional view of other loudspeaker of the present invention.

FIG. 18 is an enlarged sectional view of an edge which is an essential portion of other loudspeaker of the present invention.

FIG. 19 is a top view of a conventional slim loudspeaker.

FIG. 20 is a two-directional view of the conventional slim loudspeaker.

### DESCRIPTION OF THE PREFERRED EMBODIMENTS

### (EXAMPLE 1)

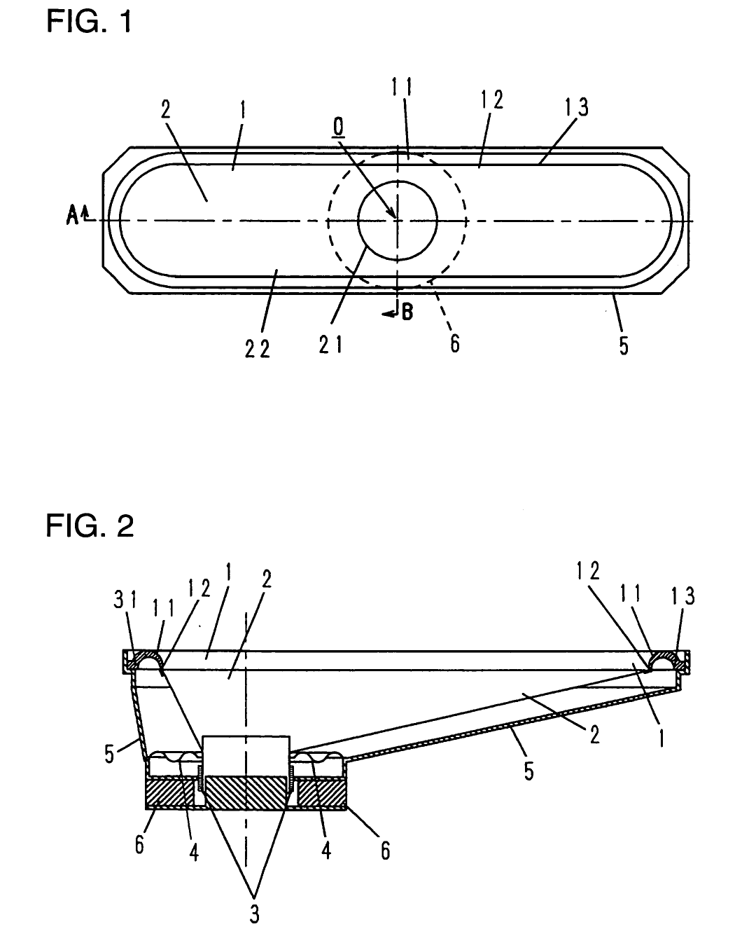

The first example of the present invention will be described in the following with reference to FIG. 1 and FIG. 2.

FIG. 1 is a top view of a slim loudspeaker in the first example of the present invention. FIG. 2 shows cross sections of the loudspeaker in two directions of AO (lengthwise direction) and BO (widthwise direction) in FIG. 1. In FIG. 2, magnetic circuit 6 comprises lower plate 6a, ring magnet 6b, and upper plate 6c. An outer periphery of diaphragm 2 is bonded via edge 1 to frame 5 which is bonded to the magnetic circuit 6, and an inner periphery of the diaphragm 2 is bonded to voice coil 3 inserted into magnetic gap 6d of the magnetic circuit 6.

An outer periphery of damper 4 is bonded to the frame 5, and an inner periphery is bonded to the voice coil 3 to support the voice coil 3.

When a signal current flows in the voice coil 3, a driving force is generated to vibrate the diaphragm 2, radiating acoustic waves corresponding to a wave forms of the signal current. The damper 4 and the edge 1 support the diaphragm 2 together at an upper and a lower positions, and the damper 4 and the edge 1 function so that the diaphragm 2 and the voice coil 3 being able to vibrate along an axial direction of the loudspeaker in a stable state.

The edge 1 of the present embodiment is made of a foamed resin mainly based on a polyurethane resin that is an elastic resin, and a sectional shape in a radial direction is, as shown in FIG. 2, a roll edge extended upward in an arc shape. Also, the edge 1 is formed so that a thickness of the inner periphery portion 12 side bonded to the diaphragm 2 of flexible portion 11 is thinner and a thickness of the outer periphery portion 13 side is thicker. Since the sectional shape is formed in this way, the thinner portion that is connected to the diaphragm 2 and mainly vibrates is light-weight, flexible, and low in mechanical impedance, thus, bad influences on the vibration mode of the diaphragm become less. At the same time, since the outer periphery portion 13 side is thicker, an absorption of vibration energy transferred from the diaphragm 2 is increased, preventing the generation of standing waves in the diaphragm 2. Preventing the generation of standing waves increases an efficiency of medium and high frequency range sounds radiated from the loudspeaker and further greatly improves frequency characteristics, nonlinear distortion characteristics, and transient characteristics. Although it is not illustrated in the figures, as an edge modified in shape from the present Example, it is also possible to use an edge with a structure such that ratios of change in thickness from the inner periphery to the outer periphery are changed according to changes in stiffness in the lengthwise and widthwise directions of the diaphragm. By using this structure, it is possible to further improve the frequency characteristics, nonlinear distortion characteristics, and transient characteristics.

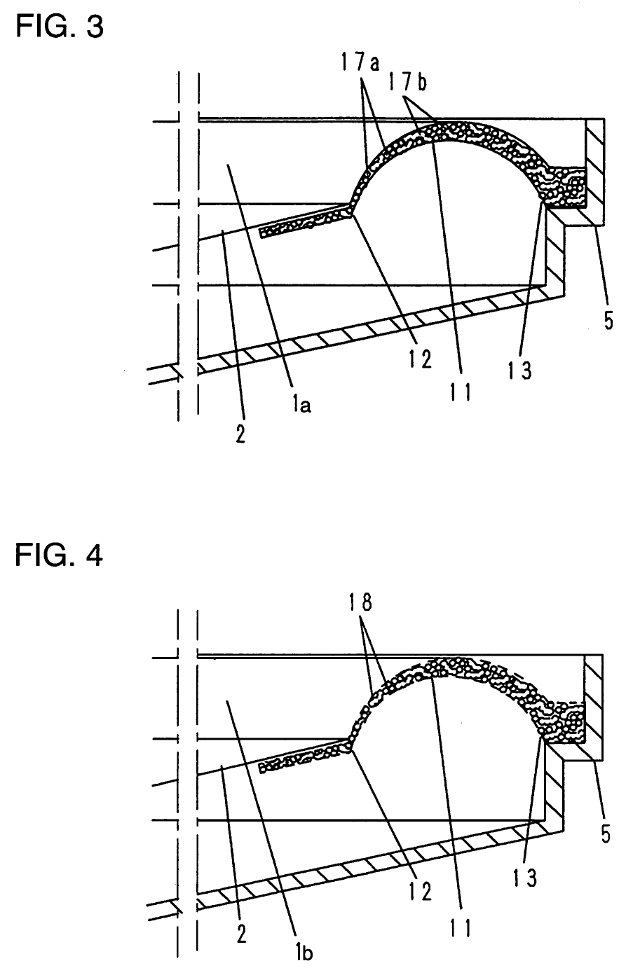

FIG. 3 shows a modification of the present example, showing an enlarged sectional shape of an edge that is an essential portion. The structural difference between the modification and the Example is that, in edge la of the modification has a foamed condition where both of independent foam 17a and continuous foam 17b coexist. Due to this structure, the edge la has gas-tight characteristic necessary as an edge, and the movement of gas in the continuous foam 17b increases the mechanical internal losses, and contribute to further improve the frequency characteristics.

FIG. 4 shows another modification of the present example, showing an enlarged sectional shape of an edge that is an essential portion. In this modification, edge 1b has skin layers 18 on both surfaces. The skin layer 18 of the surface is formed one-piece with the internal foamed layer without having clear interface. Thus, the edge 1b becomes having features of being soft and light in weight.

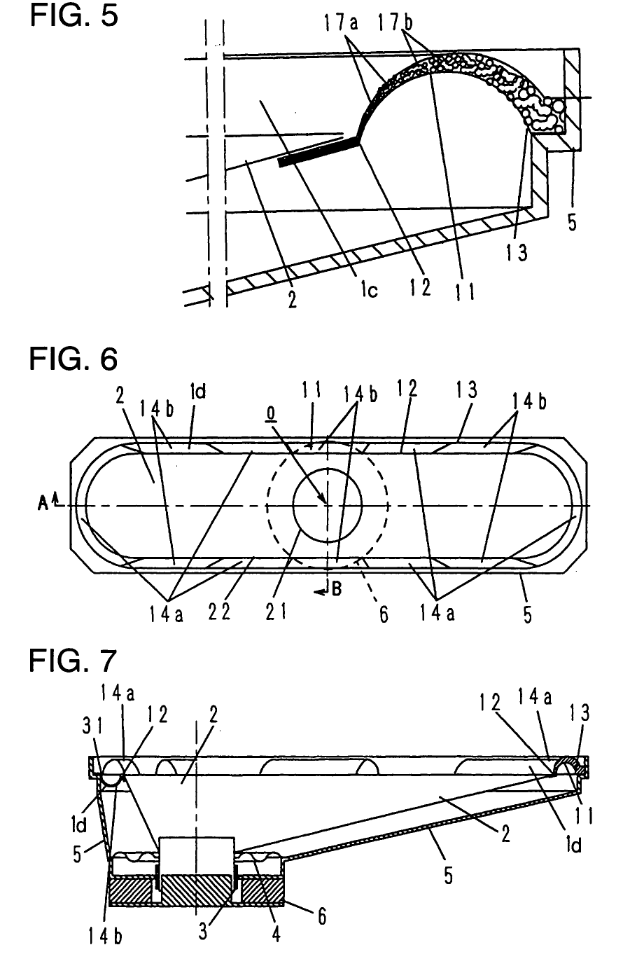

FIG. 5 is still another modification of the present example, showing an enlarged sectional shape of an edge that is an essential portion. In this modification, an expansion ratio is changed so that a density of inner periphery portion 12, or a bend portion of edge 1c, is higher than a density of an outer periphery portion 13. In this way, decrease in a strength of the thinned inner periphery is suppressed. As a methods to change the expansion ratio, two or more kinds of resins varied in an amount of foaming agent blended into the resins for molding are molded by a multi-color injection molding, or by a press molding, where a plurality of resins (generally sheet-formed) varied in the amount of foaming agent are disposed in a molding die and formed under heat and pressure. Accordingly, in the press molding, at a portion corresponding to a vicinity of inner periphery portion 12, or the bend portion, a resin less in the amount of foaming agent is disposed.

Although the illustration is omitted, a modification of a roll edge where the flexible portion 11 is bent downward in an arc shape may be used.

For the production of the edge la which includes both of the independent foam 17a and continuous foam 17b described above, a foaming thermosetting composition obtained by mechanically mixing gas with a thermosetting composition mainly based on a polyurethane prepolymer and a latent hardener is molded under heat. As the latent hardener, so-called amine adduct, obtained by inactivating solid polyamine, was used in the present example. This is also used in each of the following Examples. However, the latent hardener is not limited to the substance provided that it is dissociated under heat and form a urethane resin.

Also, the above urethane resin is preferable as a diaphragm support member, taking into account the acoustic performance for the loudspeakers, however, as a material for the edge, it is also possible to use thermosetting resin and thermoplastic resin composition made of other synthetic resin, thermoplastic elastomer, rubber or foamed resins made of the above resins.

### (EXAMPLE 2)

FIG. 6 is a top view of a slim loudspeaker in accordance another example of the present invention. FIG. 7 is a sectional view of the loudspeaker in two directions of AO and BO in FIG. 6. In the description of the present example, same component parts as those in the example 1 are given same reference numerals, and the description is omitted.

Edge 1d of the present embodiment is made of foamed resin mainly based on polyurethane resin as the same in Example 1, and its flexible portion is divided into a plurality of sections in a circumferential direction with convex portion 14a and concave portion 14b alternately arranged. Further, the boundary between the adjacent sections crosses the edge id at an angle different from the peripheral direction, and thereby, the shape smoothly changes from convex to concave without abrupt change in shape. In general, a displacement of an edge in a direction of convex and in a direction of concave are reverse in linearity with respect to a driving force, and this causes a generation of nonlinear distortion. However, in the present example, since the convex portion 14a and the concave portion 14b are alternately arranged, the generation of nonlinear distortion in the reproduced reduces because of mutual neutralization of non-linearity. Further, the unnecessary resonance of the diaphragm is suppressed by the convex and concave of the edge.

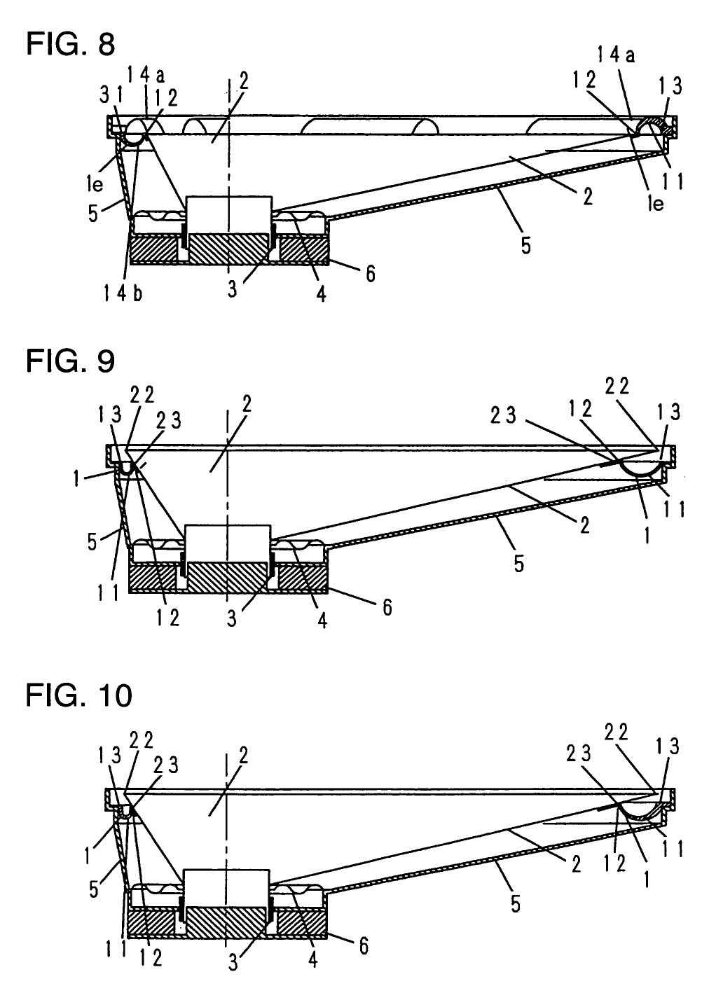

FIG. 8 shows a modification of the present example, showing a half-sectional view in the directions of AO and BO in FIG. 6, it also shows a sectional shape of edge le. The edge le is made of foamed resin mainly based on polyurethane resin as the same in the Example 1, and the flexible portion of the edge 1e is divided into a plurality of sections with convex portion 14a and concave portion 14b alternately distributed in a circumferential direction as in the present example, and also, the sectional shape in the radial direction is formed such that a thickness at the inner periphery portion 12 side is thinner, and a thickness at the outer periphery portion 13 side thicker as the same in Example 1.

Nonlinear distortion of the loudspeaker of this modification is reduced, and at the same time, the portion which is connected to the diaphragm 2 and mainly vibrates is light-weight and flexible, and is low in mechanical impedance, thereby decreasing the bad influence on the vibration mode of the diaphragm as the same in Example 1. At the same time, since the outer periphery portion 13 side is thicker, the absorption of vibration energy transferred from the diaphragm 2 is increased, thus a generation of standing waves in the diaphragm 2 can be prevented. As a result, the structure increases an efficiency of the medium and high frequency range sounds radiated from the loudspeaker, and further, greatly contributes to improve the frequency characteristics, nonlinear distortion characteristics, and transient characteristics.

### (EXAMPLE 3)

FIG. 9 is a sectional view in two directions of AO and BO of other loudspeaker having the shape of FIG. 6. In the present Example, a diameter of an inner periphery portion 12 of edge 1 made of foamed resin mainly based on a polyurethane resin as the same in Example 1 is formed smaller than a diameter of an outer periphery 22 of diaphragm 2. In the loudspeaker of the present Example, the diaphragm 2 is supported by the edge 1 with inner portion 23 formed inwardly from the outer periphery 22 thereof. According to the configuration of the present example, in a case where a same maximum dimension of a frame is employed, it is possible to improve a low frequency range sound reproduction and to increase the efficiency by maximizing an effective area of the diaphragm.

FIG. 10 shows a modification of the present example, showing a sectional view in the same direction as in FIG. 9. As the same in Example 1, the sectional shape in the radial direction of edge 1 made of foamed resin mainly based on polyurethane resin is formed, as the same as in the present example, such that a diameter of the inner periphery portion 12 is smaller than a diameter of the outer periphery 22 of diaphragm 2, and the diaphragm 2 is supported with a inner portion inward from the outer periphery 22. Further, as shown in the figure, the inner periphery portion 12 side bonded to the diaphragm 2 is formed thinner, and the outer periphery portion 13 side is formed thicker. The loudspeaker of this modification can increase the efficiency, and as the same in Example 1, it increases the efficiency of the medium and high frequency range sounds, and further, greatly contributes to improve the frequency characteristics, nonlinear distortion characteristics, and transient characteristics.

### (EXAMPLE 4)

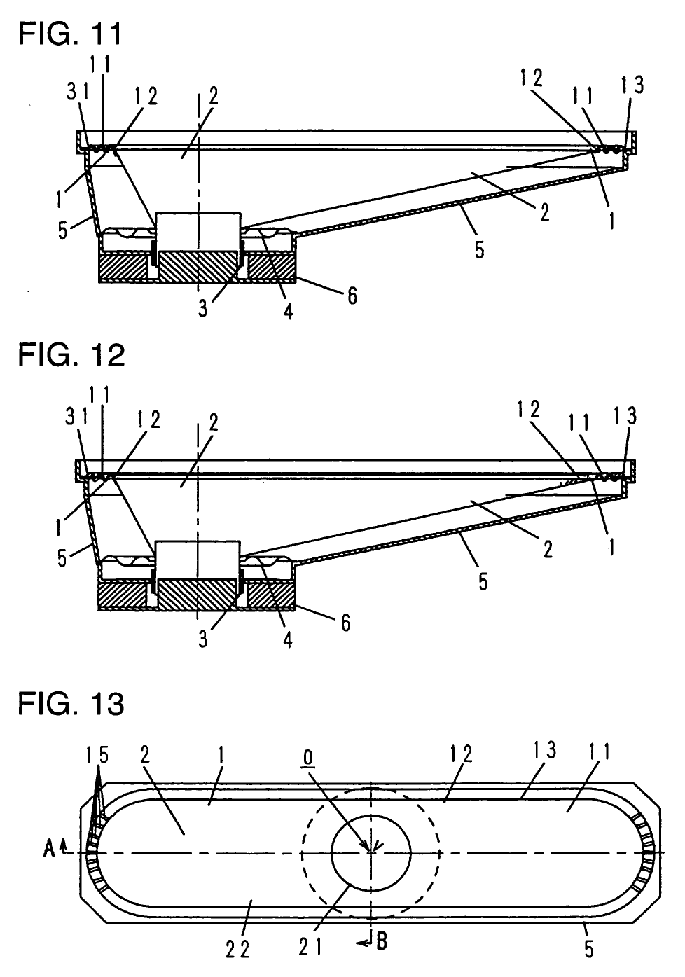

FIG. 11 shows a sectional shape in two directions, lengthwise and widthwise directions, of edge 1 bonded to the diaphragm 2 of the loudspeaker in the present example. In the present example, as the same in Example 1, the flexible portion 11 of an edge made of foamed resin mainly based on polyurethane resin is formed to have corrugated sections with narrow concave corrugations and convex corrugations alternately arranged. A non-linearity of concave corrugations compensates a non-linearity of convex corrugations, thereby decreasing a level of nonlinear distortion in a case of small amplitude.

FIG. 12 shows a modification of the present example, showing a sectional shape viewed in two directions of the edge 1. As the same in Example 1, the sectional shape in the radial direction of the edge 1 made of foamed resin mainly based on polyurethane resin is formed to have a corrugated shape as the same in the present example. Further, as shown in the figure, the sectional shape of the edge 1 is formed such that a thickness of the inner periphery portion 12 side bonded to the diaphragm 2 is thinner, and a thickness of the outer periphery portion 13 side is thicker. In a case of small amplitude, this modification decreases the level of nonlinear distortion, and as the same in Example 1, it also increases the efficiency at the medium and high frequency range sounds, and further, greatly contributes to improve the frequency characteristics, nonlinear distortion characteristics, and transient characteristics.

### (EXAMPLE 5)

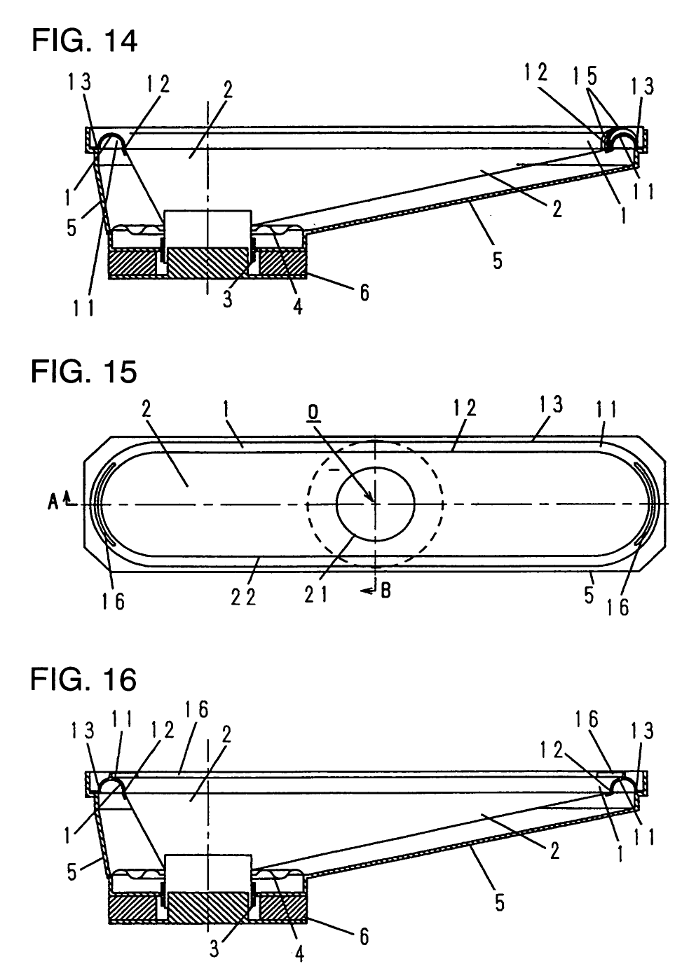

FIG. 13 is a top view of a loudspeaker in the present Example. FIG. 14 shows a sectional shape in two directions of AO and BO in FIG. 13. In the present Example, as the same in Example 1, in the lengthwise direction of the flexible portion 11 of the edge made of foamed resin mainly based on polyurethane resin, a plurality of rib-shaped convex portions (ribs) 15 are provided in radial direction by increasing resin thickness so as to change the compliance of the edge. The convex portions 15 are intended to prevent a resonance and deformation of the diaphragm by balancing with the lengthwise stiffness of the diaphragm 2 and to improve the frequency characteristics.

Also in the present Example, although the illustration is omitted, it is possible to make a plurality of modifications. For example, possible modifications include a structure in which the edge material is formed thinner at the inner periphery portion 12 side and thicker at the outer periphery portion 13 side, a structure in which a height of the ribs 15 or an effective thickness of edge portion including the height of rib 15 is thinner at the inner periphery portion 12 side and thicker at the outer periphery portion 13 side, and other various modifications.

### (EXAMPLE 6)

FIG. 15 is a top view of a loudspeaker of the present example. FIG. 16 shows a sectional view in two directions of AO and BO of the loudspeaker in FIG. 15.

In a loudspeaker of the present example, in a lengthwise direction of the flexible portion 11 of the edge made of foamed resin mainly based on polyurethane resin, as the same in Example 1, rib-shaped convex portions (rib) 16 increased in thickness of resin along the peripheral direction are partially provided in order to change the compliance of the edge. This structure is intended to prevent the resonance and deformation of the diaphragm by balancing with the lengthwise stiffness of the diaphragm 2 and to improve the frequency characteristics.

Also in the present example, although the illustration is omitted, it is possible to make a plurality of modifications. For example, a possible example of modification is such that a thickness of edge material or an effective thickness of edge portion including the height of the rib is formed thinner at the inner periphery portion 12 side and thicker at the outer periphery portion 13 side.

### (EXAMPLE 7)

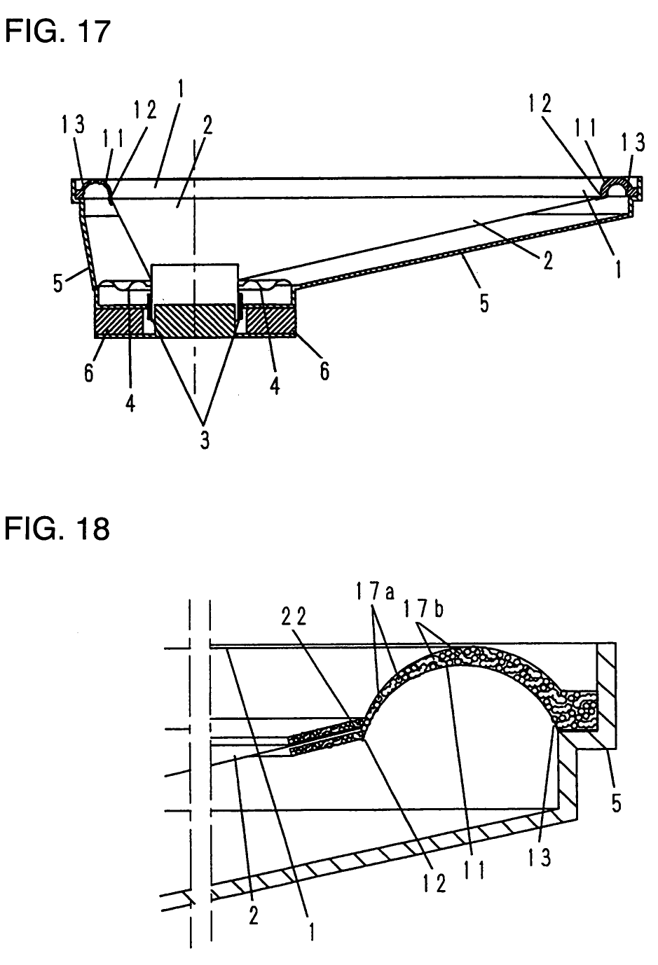

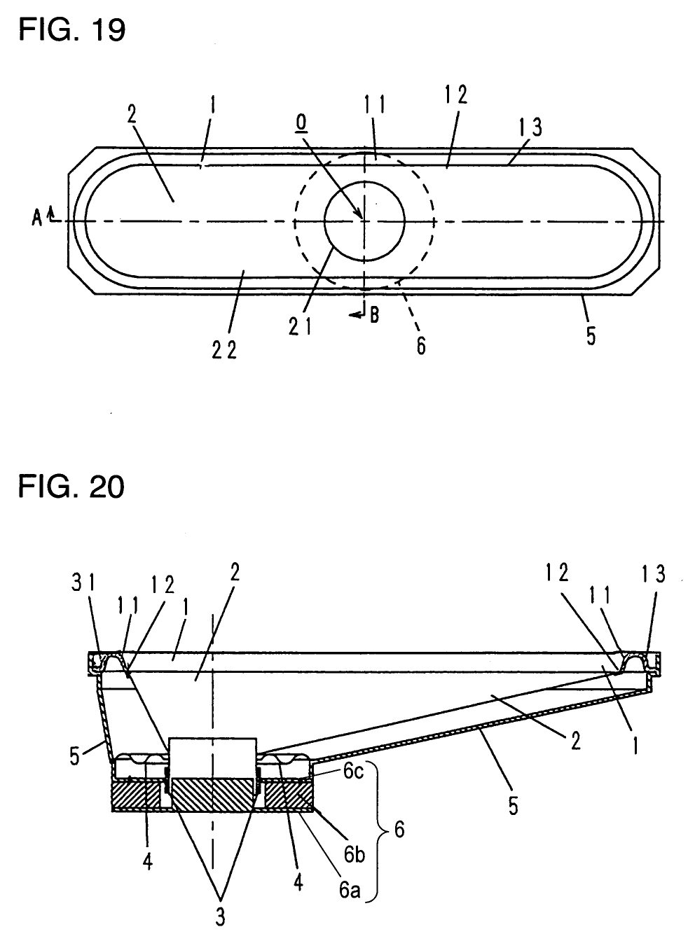

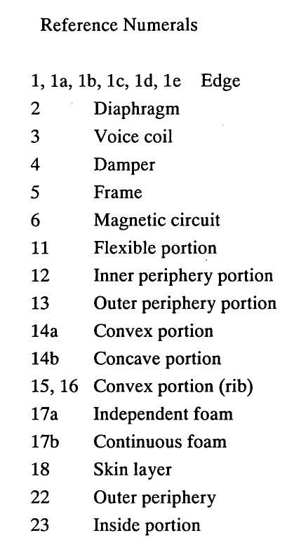

FIG. 17 shows a sectional view in two directions, lengthwise and widthwise directions, of a loudspeaker in the present example. The flexible 10 portion 11 of the edge made of foamed resin mainly based on polyurethane resin, as the same in Example 1, is partially changed in edge compliance in accordance with a change in the stiffness of the diaphragm. To achieve this purpose, a thickness of the flexible portion 11 of the edge is increased in the lengthwise direction and a thickness is decreased in the widthwise direction, and the flexible portion 11 is formed so as to smoothly change in thickness. This structure is intended to prevent the resonance and deformation of the diaphragm by balancing with the lengthwise stiffness of the diaphragm 2 and to improve the frequency characteristics.

Also in the present example, although the illustration is omitted, it is possible to make a plurality of modifications. For example, a possible example of modification is such that the structure of the present embodiment is combined with a structure wherein the substantial thickness of edge portion is formed thinner at the inner periphery portion 12 side and thicker at the outer periphery portion 13 side.

### (EXAMPLE 8)

FIG. 18 is an enlarged sectional view showing a combined structure of diaphragm 2 and edge 1 which are essential portions of the loudspeaker in the present example. In the present example, when a foaming thermosetting composition, a raw material of the edge 1, is placed in the molding die and is molded under heat, the diaphragm 2 is insert-molded to combine the edge 1 and the diaphragm 2.

Due to the insert molding, when assembling the loudspeaker, an assembling cost can be reduced because the step of bonding the edge 1 and the diaphragm 2 can be omitted. Further, both components are uniformly connected with each other under sufficient adhesive strength. Moreover, the connection does not increase a weight due to adhesive agent, thus, improves the performance of the loudspeaker.

Above described are the representative Examples and modifications of the present invention, but the present invention is not limited to the above 10 structures. For example, in the above Examples, an edge mainly using foamed urethane resin has been described. However, the edge material is not limited to such material, and it is also possible to use thermoplastic elastomers, rubbers, and the like. Thus, it is possible to use an equivalent material in terms of quality or to change the molding method including the die heating methods. Also, it is possible to perform proper change as far as the requirements for the configurations mentioned in the present invention are satisfied with respect to the structures and shapes, and the advantages described in the following can be obtained by achieving the purposes of the present invention.

### INDUSTRIAL APPLICABILITY

The speaker of the present invention, that is, the loudspeaker employing a diaphragm support mechanism, or an edge, has the following advantages. Namely, the edge having a structure where the inner periphery side is thinner and the outer periphery side is thicker, has low mechanical impedance against the diaphragm and bad influences on the vibration mode of the diaphragm are decreased. At the same time, the vibration energy is absorbed by the thick portion of the outer periphery portion, thus the standing waves of the diaphragm is suppressed, and the efficiency of medium and high frequency range sounds radiated from the loudspeaker is increased, and further, the structure greatly contributes to improve frequency characteristics, nonlinear distortion characteristics, and transient characteristics.

1. A loudspeaker comprising:
at least a magnetic circuit (6);
a frame (5) connected to said magnetic circuit; and
a diaphragm (2) connected to a voice coil (3), an outer periphery of said diaphragm being bonded to said frame via an edge (1), and an inner periphery of said diaphragm being bonded to said voice coil, said voice coil being inserted into a magnetic gap of said magnetic circuit,
wherein a thickness of sectional shape of an inner periphery portion (12) of said edge is thinner than a thickness of a sectional shape of an outer periphery portion (13) of said edge.

2. The loudspeaker of claim 1, wherein said edge is made of one of an elastic resin and a foamed resin.

3. The loudspeaker of claim 2, wherein said foamed resin includes both of independent foam and continuous foam.

4. The loudspeaker of claim 2, wherein an expansion ratio of said foamed resin differs between the inner periphery portion and the outer periphery portion of said edge.

5. The loudspeaker of claim 1, wherein said edge is made of a foamed resin having a skin layer.

6. The loudspeaker of claim 1, wherein said edge is divided into a plurality of sections in a circumferential direction with convex portions (14a) and concave portions (14b) alternately arranged.

7. The loudspeaker of claim 1, wherein a size of the inner periphery (12) of said edge is smaller than a size of the outer periphery (22) of said diaphragm.

8. The loudspeaker of claim 1, wherein a cross section of said edge has corrugations in a radial direction.

9. The loudspeaker of claim 1, wherein a plurality of rib-shaped convex portions (15) are provided in a radial direction of said edge.

10. The loudspeaker of claim 1, wherein a plurality of rib-shaped convex portions (16) are provided in a circumferential direction of said edge.

11. The loudspeaker of claim 1, wherein said loudspeaker has a long shape, and wherein a thickness of said edge in lengthwise direction is greater than a thickness of said edge in widthwise direction.

12. The loudspeaker of claim 6, wherein said loudspeaker has a long and slim shape, and wherein a variation of thickness of said edge in lengthwise direction is greater than a variation of thickness of said edge in widthwise direction.

13. The loudspeaker of claim 12, wherein a size of an inner periphery (12) of said edge is smaller than a size of an outer periphery (22) of said diaphragm.

14. The loudspeaker of claim 12, wherein a cross section of said edge has corrugation in a radial direction.

15. The loudspeaker of claim 12, wherein a plurality of rib-shaped convex portions (15) are provided in a radial direction of said edge.

16. The loudspeaker of claim 12, wherein a plurality of rib-shaped convex portions (16) are provided in a circumferential direction of said edge.

17. The loudspeaker of claim 12, wherein said loudspeaker has a long shape, and wherein a thickness of said edge in lengthwise direction is greater than a thickness of said edge in widthwise direction.

18. The loudspeaker of claim 1, wherein said diaphragm and said edge are unitary formed and bonded to said frame.

19. A loudspeaker comprising:
at least a magnetic circuit (6);
a frame (5) connected to said magnetic circuit; and
a diaphragm (2) connected to a voice coil (3), an outer periphery of said diaphragm being bonded to said frame via an edge (1), and an inner periphery of said diaphragm being bonded to said voice coil, said voice coil being inserted into a magnetic gap of said magnetic circuit,
wherein said loudspeaker has a long shape, and wherein a thickness of said edge in lengthwise direction is greater than a thickness of said edge in widthwise direction.

20. A loudspeaker comprising:
at least a magnetic circuit (6);
a frame (5) connected to said magnetic circuit; and
a diaphragm (2) connected to a voice coil (3), an outer periphery of said diaphragm being bonded to said frame via an edge (1), and an inner periphery of said diaphragm being bonded to said voice coil, said voice coil being inserted into a magnetic gap of said magnetic circuit,
wherein said edge is divided into a plurality of sections in a circumferential direction with convex portions (14a) and concave portions (14b) alternately arranged.

21. A loudspeaker comprising:
at least a magnetic circuit (6);
a frame (5) connected to said magnetic circuit; and
a diaphragm (2) connected to a voice coil (3), an outer periphery of said diaphragm being bonded to said frame via an edge (1), and an inner periphery of said diaphragm being bonded to said voice coil, said voice coil being inserted into a magnetic gap of said magnetic circuit,
wherein a size of the inner periphery (12) of said edge is smaller than a size of the outer periphery (22) of said diaphragm.

22. A loudspeaker comprising:
at least a magnetic circuit (6);
a frame (5) connected to said magnetic circuit; and
a diaphragm (2) connected to a voice coil (3), an outer periphery of said diaphragm being bonded to said frame via an edge (1), and an inner periphery of said diaphragm being bonded to said voice coil, said voice coil being inserted into a magnetic gap of said magnetic circuit,
wherein a cross section of said edge has corrugations in a radial direction.

23. A loudspeaker comprising:
at least a magnetic circuit (6);
a frame (5) connected to said magnetic circuit; and
a diaphragm (2) connected to a voice coil (3), an outer periphery of said diaphragm being bonded to said frame via an edge (1), and an inner periphery of said diaphragm being bonded to said voice coil, said voice coil being inserted into a magnetic gap of said magnetic circuit,
wherein a plurality of rib-shaped convex portions (15) are provided in one of a radial direction and a circumferential direction of said edge.

24. A loudspeaker comprising:
at least a magnetic circuit (6);
a frame (5) connected to said magnetic circuit; and
a diaphragm (2) connected to a voice coil (3), an outer periphery of said diaphragm being bonded to said frame via an edge (1), and an inner periphery of said diaphragm being bonded to said voice coil, said voice coil being inserted into a magnetic gap of said magnetic circuit,
wherein said diaphragm and said edge are unitary formed and bonded to said frame.

25. The loudspeaker of claim 2, wherein said edge is divided into a plurality of sections in a circumferential direction with convex portions (14a) and concave portions (14b) alternately arranged.

26. The loudspeaker of claim 2, wherein a size of the inner periphery (12) of said edge is smaller than a size of the outer periphery (22) of said diaphragm.

27. The loudspeaker of claim 2, wherein a cross section of said edge has corrugations in a radial direction.

28. The loudspeaker of claim 2, wherein a plurality of rib-shaped convex portions (15) are provided in a radial direction of said edge.

29. The loudspeaker of claim 2, wherein a plurality of rib-shaped convex portions (16) are provided in a circumferential direction of said edge.

30. The loudspeaker of claim 2, wherein said loudspeaker has a long shape, and wherein a thickness of said edge in lengthwise direction is greater than a thickness of said edge in widthwise direction.

31. The loudspeaker of claim 2, wherein said diaphragm and said edge are unitary formed and bonded to said frame.
